(19) United States
(12) Patent Application Publication
(10) Pub. No.: US 2026/0093292 A1
(43) Pub. Date: Apr. 2, 2026

(54) SLIDABLE DEVICE AND DISPLAY DEVICE INCLUDING THE SAME

(71) Applicant: Samsung Display Co., LTD., Yongin-si (KR)

(72) Inventor: Sung-Won KIM, Yongin-si (KR)

(21) Appl. No.: 19/273,329

(22) Filed: Jul. 18, 2025

(30) Foreign Application Priority Data
Sep. 27, 2024 (KR) 10-2024-0132052

(51) Int. Cl. G06F 1/16

(52) U.S. Cl. CPC G06F 1/1681; G06F 1/1624; G06F 1/1652

(57) ABSTRACT

A display device includes: a display panel defining a screen and including a first screen portion and a second screen portion, which are distinct from each other; a support plate including a first side to which the display panel is attached, and a second side, where the support plate includes a first support portion corresponding to the first screen portion and a second support portion corresponding to the second screen portion; a hinge portion disposed in the second support portion to allow the second support portion to be fold and unfold; a hinge cap protruding from the second side while covering the hinge portion; and a drive roller including gear teeth protruded from an external circumferential surface thereof to interlock with the hinge cap.

This application claims priority to Korean Patent Application No. 10-2024-0132052, filed on Sep. 27, 2024, and all the benefits accruing therefrom under 35 U.S. C. § 119, the content of which in its entirety is herein incorporated by reference.

### BACKGROUND

### 1. Field

Embodiments of the disclosure relate to a slidable device and a display device including the slidable device.

### 2. Description of the Related Art

With recent advances in display technology, various transformable flexible display devices capable of expanding display screens by folding, rolling, stretching, or sliding methods are being researched and developed. Such a flexible display device offers the merit of being able to enlarge the display during use or miniaturize the size thereof for portability.

Among flexible display devices, a slidable display device has a structure that can expand or contract the display screen in a sliding manner. The slidable display device may include a display panel that displays an image and a support structure that supports the display panel, and the size and shape of the display panel may be changed depending on whether the slidable display device is in a slide-out state or in a slide-in state.

### SUMMARY

Conventional slidable display devices may be desired to be improved in structural stability and expandability. In particular, technical improvements are desired to minimize panel wrinkles or damage that may occur during the sliding process and to improve the durability and expandability of the support structure.

Embodiments of the disclosure provide a slidable device having a structure that can stably implement a wider screen even when the size of the device is limited, and a display device including the slidable device.

A display device according to an embodiment includes: a display panel defining a screen, where the display panel includes a first screen portion and a second screen portion, which are distinct from each other; a support plate including a first side and a second side, which are opposite to each other, where the display panel is attached to the first side, and the support plate includes a first support portion corresponding to the first screen portion and a second support portion corresponding to the second screen portion; a hinge portion disposed in the second support portion, where the hinge portion allows the second support portion to be folded and unfolded; a hinge cap protruding from the second side while covering the hinge portion; and a drive roller including gear teeth protruded from an external circumferential surface thereof to interlock with the hinge cap.

In an embodiment, the hinge portion may include a pair of joining edges to which a pair of divided segments of the second support portion are rotatably joined, respectively, and the hinge cap may define a space in which the pair of joining edges is accommodated.

In an embodiment, the pair of joining edges may have a rotating gear-engaged structure.

In an embodiment, each of the pair of joining edges may include a fastening groove extending in a first direction, and the hinge cap may include a fastening rod which extends in the first direction and is engaged in the fastening groove.

In an embodiment, the fastening rod may include a guide protrusion protruding in the first direction from the pair of joining edges.

In an embodiment, the hinge cap may include a top surface facing the external circumferential surface when meeting the drive roller and a pair of side surfaces facing the gear teeth, and the pair of side surfaces may extend from the top surface in directions away from each other.

In an embodiment, the hinge portion may include a pair of hinge portions which are adjacent to each other, and the display device may further include a pair of track bars which protrudes from the second side between the pair of hinge portions and extends in a first direction in the second support portion.

In an embodiment, the hinge portion may include a pair of hinge portions which are adjacent to each other, and the second support portion may include a bending area which is folded and unfolded and disposed between the pair of hinge portions.

In an embodiment, the display device may further include a guide stick extending in the first direction on the second side in the bending area.

A display device according to an embodiment includes: a display panel defining a screen, where the display panel includes a first screen portion and a second screen portion, which are distinct from each other; a housing defining an internal space where the display panel is accommodated, where and an opening, through which the screen is exposed, is defined in the housing, and the housing is configured to be reduced for exposure of the first screen portion or expanded for exposure of the first screen portion and the second screen portion; a support plate at least partially accommodated in the internal space of the housing, where the support plate includes a first side and a second side, which are opposite to each other, the display panel is attached to the first side, and the support plate includes a first support portion corresponding to the first screen portion and a second support portion corresponding to the second screen portion; a hinge portion disposed in the second support portion, where the hinge portion allows the second support portion to be folded and unfolded; a hinge cap protruding from the second side while covering the hinge portion; and a drive roller accommodated in the internal space of the housing, where the drive roller includes gear teeth protruding from an external circumferential surface thereof to interlock with the hinge cap.

In an embodiment, the hinge portion may include a pair of hinge portions which are adjacent to each other, and the second support portion may include a bending area which is folded and unfolded and disposed between the pair of hinge portions.

In an embodiment, the display device may further include a guide stick extending in a first direction on the second side in the bending area.

In an embodiment, the housing may include a first guide rail extending along a sliding path of the bending area, and the guide stick may be restricted to move along the first guide rail.

In an embodiment, the hinge portion may include a pair of joining edges to which a pair of divided segments of the second support portion are rotatably joined, respectively, and the hinge cap may have a space in which the pair of joining edges is accommodated.

In an embodiment, each of the pair of joining edges may include a fastening groove extending in a first direction, and the hinge cap may include a fastening rod which extends in the first direction and is engaged in the fastening groove.

In an embodiment, the fastening rod may include a guide protrusion protruding in the first direction from the pair of joining edges.

In an embodiment, the housing may include a second guide rail extending along a sliding path of the hinge portion, and the guide protrusion may be restricted to move along the second guide rail.

A slidable device according to an embodiment includes: a support plate including a first side and a second side, which face each other, and a first support portion and a second support portion, which are distinct from each other; a hinge portion disposed in the second support portion, where the hinge portion allows the second support portion to be folded and unfolded; a hinge cap protruding from the second side while covering the hinge portion; and a drive roller including gear teeth protruding from an external circumferential surface thereof to interlock with the hinge cap.

In an embodiment, The hinge portion may include a pair of hinge portions which are adjacent to each other, and the second support portion may further include a pair of track bars which protrudes from the second side between the pair of hinge portions and extends in a first direction in the second support portion.

In an embodiment, the second support portion may include a bending area which is folded and unfolded and disposed between the pair of track bars.

In an embodiment, the slidable device may further include a guide stick extending in the first direction on the second side in the bending area.

In an embodiment, the slidable device may further include a housing configured to be reduced for exposure of the first support portion or expanded for exposure of the first support portion and the second support portion, where the housing may include a first guide rail extended along a sliding path of the bending area, and the guide stick may be restricted to move along the first guide rail.

In an embodiment, the hinge portion may include a pair of joining edges to which a pair of divided segments of the second support portion are rotatably joined, respectively, and the hinge cap may define a space in which the pair of joining edges is accommodated.

In an embodiment, the pair of joining edges may have a rotating gear-engaged structure.

In an embodiment, each of the pair of joining edges may include a fastening groove extending in a first direction, and the hinge cap may include a fastening rod which extends in the first direction and is engaged in the fastening groove.

In an embodiment, the fastening rod may include a guide protrusion protruding in the first direction from the pair of joining edges.

In an embodiment, the slidable device may further include a housing configured to be reduced for exposure of the first support portion or expanded for exposure of the first support portion and the second support portion, where the housing may include a second guide rail extending along a sliding path of the hinge portion, and the guide protrusion may be restricted to move along the second guide rail.

In an embodiment, the hinge cap may include a top surface facing the external circumferential surface when meeting the drive roller and a pair of side surfaces facing the gear teeth, and the pair of side surfaces may extend from the top surface in directions away from each other.

In the slidable device or the display device according to embodiments of the disclosure, a wider screen can be stably implemented even when the size of the device is limited.

In such embodiments, since the guide protrusion or guide stick is provided to a slidable driven support plate and is restricted to move along a guide rail arranged inside the housing, the sliding motion of the support plate can be stably guided.

### BRIEF DESCRIPTION OF THE DRAWINGS

FIG. 1 is a perspective view of a display device in a slide-in state according to an embodiment.

FIG. 2 is a bottom view and a front view of the display device of FIG. 1.

FIG. 3 is a perspective view of the display device in a slide-out state according to an embodiment.

FIG. 4 is a bottom view and a front view of the display device of FIG. 3.

FIG. 5 is an enlarged cross-sectional view of a part of the display device of FIG. 3.

FIG. 6 is a partially enlarged perspective view of a portion of the slidable device applied to the display device shown in FIG. 1.

FIG. 7 is a front view of FIG. 6.

FIG. 8 is an enlarged front view of the second support portion of the slidable device shown in FIG. 6.

FIG. 9 is a partial perspective view provided for description of a process of assembling a hinge cap to a joining edge of the segment in the slidable device shown in FIG. 6.

FIG. 10 is a partially enlarged perspective view of the slidable device applied to the display device shown in FIG. 3.

FIG. 11 is a front view of FIG. 10.

FIG. 12 shows the slidable device, the first guide rail, and the second guide rail together in a state before the display device according to an embodiment is expanded.

FIG. 13 shows the slidable device, the first guide rail, and the second guide rail together in a state after the display device according to an embodiment is expanded.

FIG. 14 shows a slidable device together with a first guide rail in a state before expansion of display device according to another embodiment.

FIG. 15 shows a slidable device together with a second guide rail in a state before expansion of display device according to still another embodiment.

FIG. 16 is a perspective view of a slidable device applied to a display device according to another embodiment.

FIG. 17 is a block diagram of an electronic device according to an embodiment.

FIG. 18 shows schematic diagrams of electronic devices according to various embodiments.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

In order to clearly explain the disclosure, parts that are not related to the description are omitted, and the same reference symbols are used for identical or similar components throughout the specification.

In addition, the size and thickness of each component shown in the drawing are arbitrarily illustrated for better understanding and ease of description, and the disclosure is not necessarily limited to what is illustrated. In the drawings, the thickness of layers, films, panels, regions, etc., are exaggerated for clarity. In addition, for better understanding and ease of description, the thickness of some layers and regions may be exaggerated.

It will be understood that when an element such as a layer, film, region, or substrate is referred to as being “on” another element, it can be directly on the other element or intervening elements may also be present. In contrast, when an element is referred to as being “directly on” another element, there are no intervening elements present. In addition, being “above” or “on” the referenced part means being disposed above or below the referenced part, and does not necessarily mean being disposed “above” or “on” the opposite direction of gravity.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath”can, therefore, encompass both an orientation of above and below.

Further, throughout the specification, the phrase “on a plane” means viewing a target portion from the top, and the phrase “on a cross-section” means viewing a cross-section formed by vertically cutting a target portion from the side.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

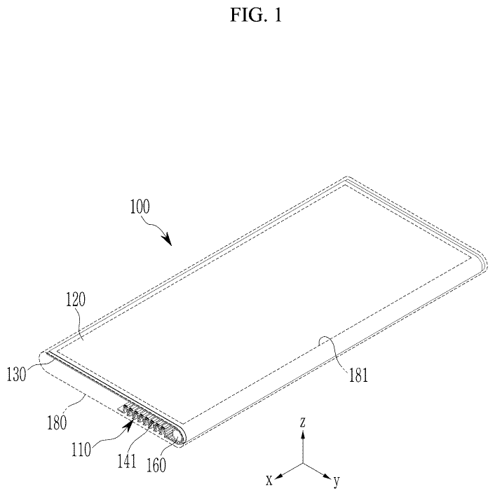

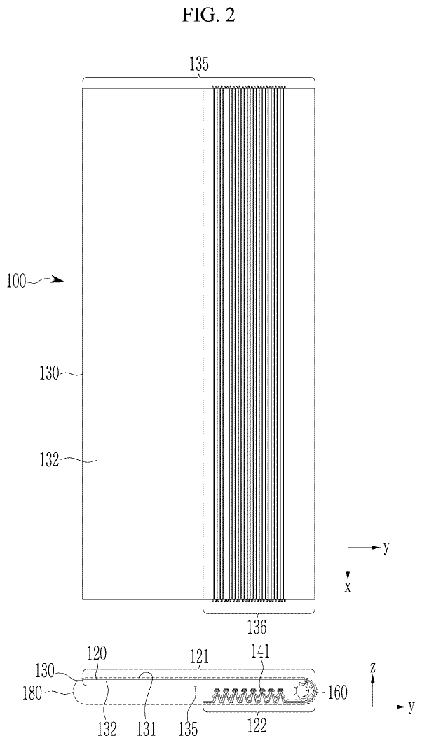

FIG. 1 is a perspective view of a display device in a slide-in state according to an embodiment, and FIG. 2 is a bottom view and a front view of the display device of FIG. 1.

Referring to FIG. 1 and FIG. 2, a display device 100 according to an embodiment is a display device including a slidable device 110 capable of sliding operation, and includes a display panel 120 configured to display a screen and a support plate 130 to which one surface of the display panel 120 is attached. The display panel 120 and the support plate 130 may be accommodated in an internal space of a housing 180, and the housing 180 may define an opening 181 for exposing a screen of the display panel 120.

In an embodiment, the display panel 120 includes a substrate where a plurality of pixels capable of displaying an image in the x-y plane are formed. Each pixel may include at least one transistor and a light emitting element. The display panel 120 may have a display surface that can display an image in the z-axis direction in FIG. 1, i.e., on the opposite side to the side where the support plate 130 is disposed, and may be wholly or partially flexible.

In an embodiment, as shown in FIG. 2, the support plate 130 includes a first side (or first surface) 131 and a second side (or second surface) 132 that are opposite to each other, and the display panel 120 may be attached to the first side 131. The display panel 120 includes a first screen portion 121 and a second screen portion 122, which are distinct from each other, and the support plate 130 includes a first support portion 135 corresponding to the first screen portion 121 and a second support portion 136 corresponding to the second screen portion 122. The housing 180 may be reduced to expose only the first screen portion 121 or expanded to expose both the first screen portion 121 and the second screen portion 122. The area of the opening 181 may be reduced or expanded as the housing 180 is reduced or expanded. In an embodiment, for example, the support plate 130 may include metal or glass.

When the display device 100 is in a slide-in state, the housing 180 of the display device 100 remains in a contracted state, the first screen portion 121 may be exposed through the opening 181 of the housing 180, and the second screen portion 122 may be accommodated inside the housing 180 and not exposed. The first support portion 135 of the support plate 130 supports the first screen portion 121 and may be disposed to correspond to the opening 181 of the housing 180. The second support portion 136 of the support plate 130 supports the second screen portion 122 and may be accommodated in the internal space of the housing 180.

A drive roller 160 is provided in the internal space of the housing 180, which rotates and slides the support plate 130. The drive roller 160 extends in a first direction (x-axis direction in the drawing) and may be disposed at either end along a second direction (y-axis direction in the drawing) intersecting the first direction in the internal space of the housing 180. The drive roller 160 may drive the support plate 130 in the positive (+) y-axis or negative (−) y-axis direction by rotating around an axis parallel to the first direction.

As the drive roller 160 rotates clockwise, the second support portion 136, which moves into the housing 180, may be accommodated in the internal space of the housing 180 in a folded state or by being folded at a hinge portion 141 (refer to FIG. 2). The second support portion 136 includes a plurality of hinge portions 141, each of which may be folded in one direction. In addition, the second support portion 136 may be folded in a direction opposite to that of the hinge portions 141 at a portion between a pair of adjacent hinge portions 141. Therefore, the second support portion 136 may be accommodated in a wrinkled state having a zigzag shape in the internal space of the housing 180.

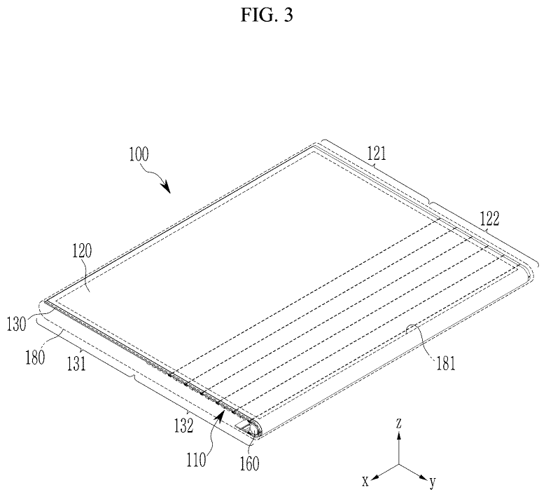

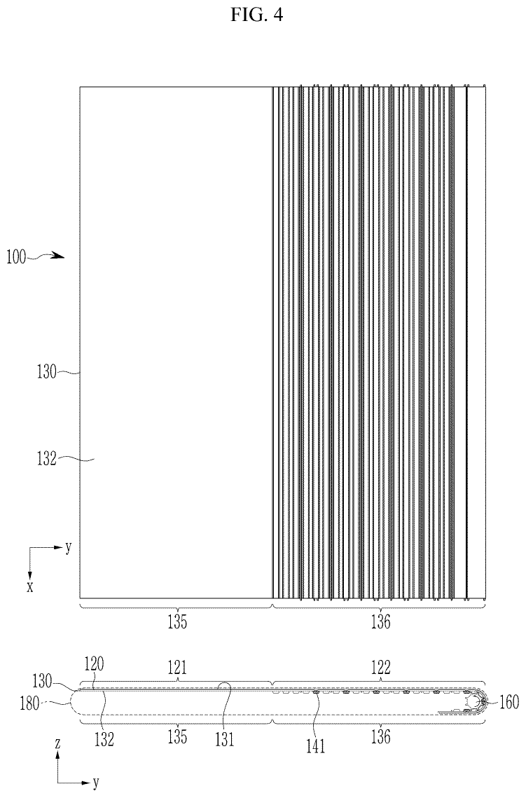

FIG. 3 is a perspective view of the display device in a slide-out state according to an embodiment, and FIG. 4 is a bottom view and a front view of the display device of FIG. 3.

Referring to FIG. 3 and FIG. 4, when the display device 100 is in a slide-out state, the housing 180 of the display device 100 maintains the expanded state, and the first screen portion 121 and the second screen portion 122 may be exposed through the opening 181 of the housing 180. The first support portion 135 and the second support portion 136 of the support plate 130 may be disposed to correspond to the opening 181 of the housing 180.

One end portion of the second support portion 136, located away from the first support portion 135, may remain engaged with the drive roller 160 even in the slide-out state. Here, the opening 181 of the housing 180 may extend to the front (a side facing the z-axis direction of the drawing) as well as a portion of a side surface (a side facing the y-axis direction of the drawing) of the display device 100, and a portion of the second screen portion 122 may display a screen from the side surface of the display device 100.

As the drive roller 160 rotates in the counterclockwise direction, the second support portion 136, which is accommodated in the internal space of the housing 180, is switched to an unfolded state in the hinge portion 141 and may correspond to the opening 181 (refer to FIG. 4). While being driven to be unfold at each of the plurality of hinge portions 141, the second support portion 136 may also be converted to an unfolded state at a portion between a pair of adjacent hinge portions 141. As a result, the second support portion 136, which has been moved to correspond to the opening 181, becomes flat and may stably support the second screen portion 122. The display device 100 may display a screen in a region extended by the first screen portion 121 and the second screen portion 122 after being expanded in a slide-out state.

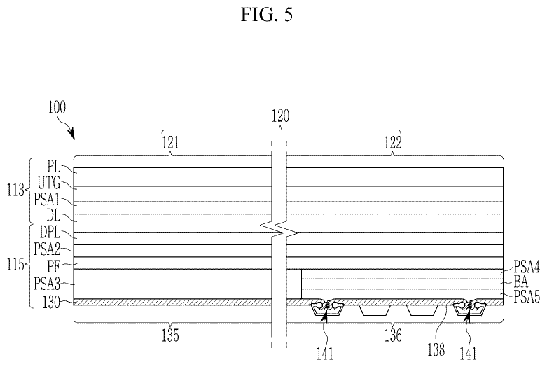

FIG. 5 is an enlarged cross-sectional view of a part of the display device of FIG. 3.

Referring to FIG. 5, in an embodiment, the support plate 130 of the display device 100 may include the first support portion 135 and the second support portion 136 that are distinct (have different structures) from each other, and the display panel 120 may include the first screen portion 121 and the second screen portion 122 that are disposed continuously over the first support portion 135 and the second support portion 136. The first screen portion 121 is a flat portion that is laminated and fixed on the first support portion 135 and remains flat even when the display device 100 is slide-driven. The second screen portion 122 is a sliding portion that is laminated on the second support portion 136 and slides when the display device 100 is slide-driven and is hidden into the internal space of the housing of the display device 100.

The display device 100 may include an upper layer 113 and a lower layer 115 which may be divided one from another based on a display layer DPL. In an embodiment, for example, the upper layer 113 is disposed above the display layer DPL and the lower layer 115 may include the display layer DPL, and the display layer DPL may be an uppermost layer of the lower layer 115. The upper layer 113 may include configurations that protect the display layer DPL from the external environment without obscuring the displayed image from the display layer DPL. The lower layer 115 may include configurations that secure the display layer DPL to the slide device while protecting and reinforcing the display layer DPL and move the display layer DPL according to the slide driving.

In an embodiment, for example, the upper layer 113 may include a damping layer DL, an ultra-thin tempered glass (UTG) layer, and a protective layer PL sequentially disposed on the display layer DPL. A first pressure sensitive adhesive layer PSA1 is interposed between the damping layer DL and the tempered UTG layer to provide adhesive strength. The lower layer 115 may sequentially include a protective film PF and a support plate 130 below the display layer DPL. The first support portion 135 of the support plate 130 may include a flat metal plate. The second support portion 136 of the support plate 130 may include a plurality of sections 138 connected to each other via the hinge portions 141. A second pressure sensitive adhesive layer PSA2 is interposed between the display layer DPL and the protective film PF, and a third pressure sensitive adhesive layer PSA3 is interposed between the protective film PF and the first support portion 135 to provide adhesive strength. In addition, a barrier layer BA may be disposed between the protective film PF and the second support portion 136, and a fourth pressure sensitive adhesive layer PSA4 and a fifth pressure sensitive adhesive layer PSA5 may be interposed between the protective film PF and the barrier layer BA and between the barrier layer BA and the second support portion 136, respectively, to provide adhesive strength. The barrier layer BA may improve the performance and lifespan of the display layer by effectively preventing the penetration of moisture and oxygen from the external environment and providing resistance to mechanical stress.

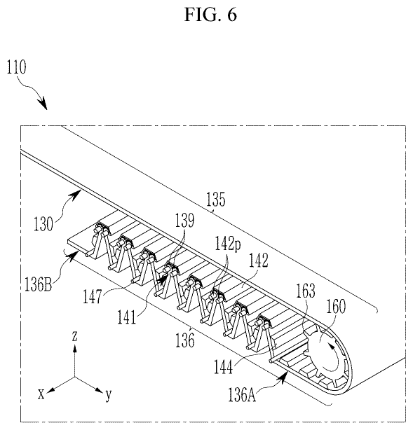

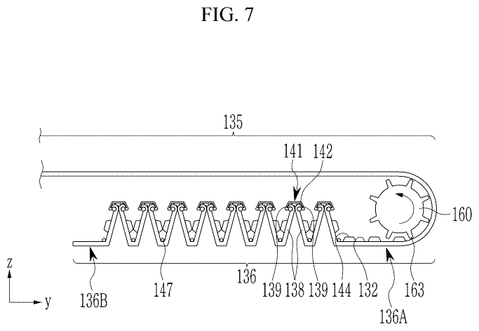

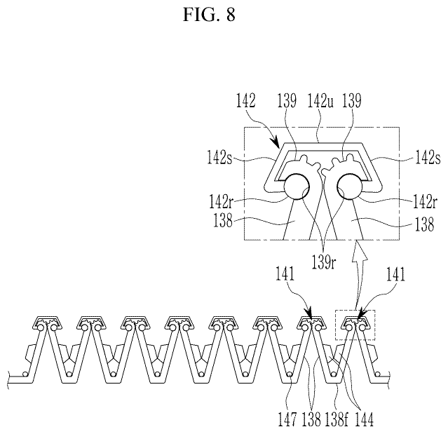

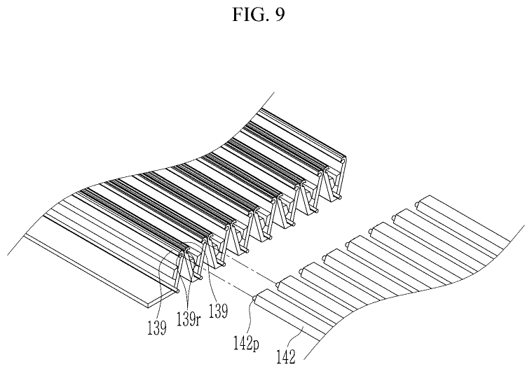

FIG. 6 is a partially enlarged perspective view of a portion of the slidable device applied to the display device shown in FIG. 1, and FIG. 7 is a front view of FIG. 6. FIG. 8 is an enlarged front view of the second support portion of the slidable device shown in FIG. 6. FIG. 9 is a partial perspective view provided for description of a process of assembling a hinge cap to a joining edge of the segment in the slidable device shown in FIG. 6.

Referring to FIG. 6 and FIG. 7, in an embodiment of the slidable device 110, the second support portion 136 of the support plate 130 includes a plurality of hinge portions 141 configured to enable folding and unfolding operations. That is, the plurality of hinge portions 141 may allow the second support portion 136 to be folded or unfolded. The plurality of hinge portions 141 may each include a pair of joining edges 139 where a pair of segments 138 adjacent to each other are coupled to each other. Each of the plurality of hinge portions 141 may be covered with a hinge cap 142 extending in the first direction.

The segment 138 may have a narrow and long strip shape extending in the first direction (x-axis direction in the drawing). The joining edge 139 may be disposed on each edge of the segment 138 along the second direction (y-axis direction in the drawing) and may extend along the first direction. However, a front end portion 136A of the second support portion 136 extending from the first support portion 135 may be provided with the joining edge 139 only on one rear side. The front end portion 136A and the segment 138 immediately adjacent thereto may form the first hinge portion 141. In addition, a rear end portion 136B of the second support portion 136 may be provided with a joining edge 139 only on one front side. The rear end portion 136B and the segment 138 immediately adjacent thereto may form the last hinge portion 141.

The drive roller 160 may be configured to rotate and drive the second support portion 136 of the support plate 130 while being positioned to one side along the second direction within the housing 180. In an embodiment, the drive roller 160 may include gear teeth 163 along an external circumferential surface thereof, and the second support portion 136 may include a track bar 144 on the second side 132. The gear teeth 163 protrude in a radial direction from the external circumferential surface of the drive roller 160, and the track bar 144 may protrude from the second side 132 of the second support portion 136. In addition, the gear teeth 163 and the track bar 144 each may be extended in the first direction. In an embodiment, for example, the track bar 144 may include metal and may be attached to the second support portion 136 via a hot-pressed process or adhesive tape.

Referring to FIG. 8 and FIG. 9, in an embodiment, a pair of joining edges 139 may be joined with each other to allow relative rotation, and, for example, may have a rotation gear-engaged structure. That is, the pair of joining edges 139 may include gear teeth that can interlock and rotate at portions where the gear teeth contact each other. The hinge cap 142 may define a space to accommodate a pair of joining edges 139. The space in the hinge cap 142 may accommodate meshing gear teeth of the pair of joining edges 139 that rotate together.

Each of the pair of joining edges 139 may have a fastening groove 139r extending in the first direction. The fastening groove 139r may be disposed on the opposite side of the part where the gear teeth are formed. The hinge cap 142 may include a fastening rod 142r that is engaged to the fastening groove 139r. The fastening rod 142r may be integrally formed with the hinge cap 142 as a part of the hinge cap 142.

The hinge cap 142 may be joined to the segment 138 by inserting the fastening rod 142r into the fastening groove 139r of the joining edge 139. In an embodiment, for example, since the fastening rod 142r and the fastening groove 139r extend in the same direction, the hinge cap 142 and the segment 138 may be joined with each other by pushing in the first direction while aligning the pair of fastening rods 142r of the hinge cap 142 with each fastening groove 139r of the pair of joining edges (refer to FIG. 9).

The fastening rod 142r may include guide protrusions 142p that protrudes in the first direction from each of the pair of joining edges 139. That is, the fastening rod 142r including the guide protrusion 142p may be extended to a length longer in the first direction than a length of the segment 138 in the first direction. Therefore, although the fastening rod 142r is engaged with the fastening groove 139r, the guide protrusion 142p may protrude from the end of the segment 138 (refer to FIG. 6). The guide protrusion 142p may be restricted to move along a guide rail formed inside the housing 180. As a result, the sliding motion of the second support portion 136 may be stably guided.

The hinge cap 142 includes a top surface 142u and a pair of side surfaces 142s. A pair of side surfaces 142s may extend from the top surface 142u in directions away from each other such that the hinge cap 142 may have an approximate trapezoid shape. When contacting the drive roller 160, the top surface 142u of the hinge cap 142 may face the external circumferential surface of the drive roller 160, and the pair of side surfaces 142s may face the gear teeth 163.

The track bar 144 may be disposed between a pair of adjacent hinge portions 141. A pair of track bars 144 may be disposed between each of the plurality of hinge portions 141. In addition, the second support portion 136 may include a foldable bending area 138f between the pair of track bars 144. The bending area 138f may be implemented by a method of pre-folding to generate a shape or by slightly thinning a thickness of the corresponding portion, but the disclosure is not limited thereto.

When viewed from the front, the pair of segments 138 constituting the hinge portion 141 are disposed close to each other while performing relative rotation about a center of the fastening groove 139r as the rotation axis, and thus the second support portion 136 is in a folded state. In this case, the bending area 138f is also folded such that the second support portion 136 has a zigzag shape. When the pair of segments 138 are disposed away from each other through relative rotation, the second support portion 136 becomes unfolded. In this case, the bending area 138f may also be unfolded together.

The guide stick 147 may be disposed on the second side 132 in the bending area 138f of the second support portion 136. The guide stick 147 may be extended in the first direction and may be protruded in the first direction from the end of the segment 138 of the second support portion 136. That is, a length of the guide stick 147 in the first direction may be extended longer than a length of segment 138 in the first direction (refer to FIG. 6). The guide stick 147 may be restricted to move along a guide rail formed within the housing 180. Accordingly, the sliding motion of the second support portion 136 may be stably guided. The guide stick 147 may be fixed to the second side 132 of the second support portion 136.

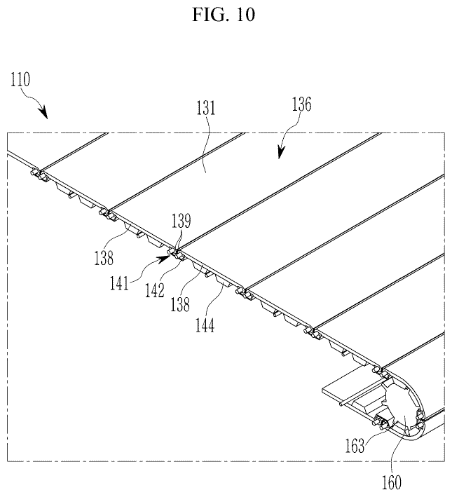

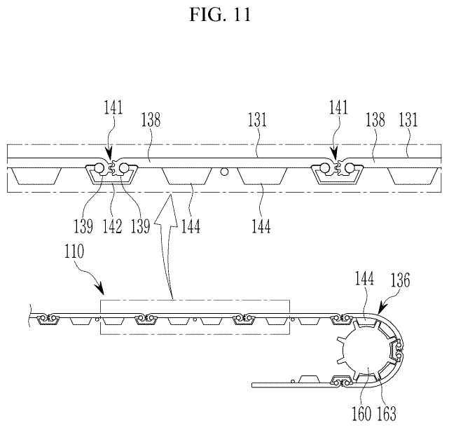

FIG. 10 is a partially enlarged perspective view of the slidable device applied to the display device shown in FIG. 3, and FIG. 11 is a front view of FIG.

### 10.

Referring to FIG. 10 and FIG. 11, in an embodiment of the display device 100 in a slide-out state, the slidable device 110 may be extended by being drawn out from the interior space of the housing 180 (refer to FIG. 4) to the second support portion 136 of the support plate 130. The plurality of segments 138 divided with reference to hinge portions 141 may be aligned side by side with the joining edges 139 adjacent to each other. Each of the plurality of segments 138 may be unfolded in a flat form such that the first sides 131 thereof lie on a same plane.

When the drive roller 160 of the slidable device 110 is rotated to expand the display device 100, the gear teeth 163 engage the track bars 144 of the second support portion 136 and the track bars 144 move in the rotating direction of the drive roller 160. As the track bars 144 move, the second support portion 136 also moves, and the hinge portions 141 disposed on the second support portion 136 also gradually move closer to the drive roller 160. As the hinge portions 141 approach the drive roller 160, the segments 138 constituting the hinge portions 141 are gradually unfolded while rotating about the joining edges 139. When the hinge portion 141 meets the drive roller 160, the segments 138 may be fully unfolded. In this case, the hinge cap 142 covering the hinge portion 141 may move along the exterior circumference of the drive roller 160 while being engaged between the gear teeth 163 of the drive roller 160.

The second support portion 136 of the support plate 130 passed by the drive roller 160 may be maintained flat with the first side 131 facing upward. Here, since the second side 132 of the second support portion 136 faces the inside of the housing 180, the track bars 144 and the hinge caps 142 protruding from the second side 132 may not protrude outward.

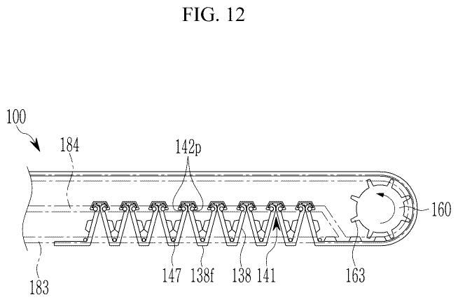

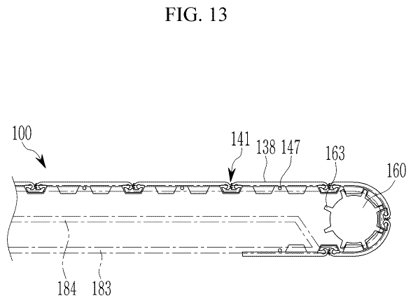

FIG. 12 shows the slidable device, the first guide rail, and the second guide rail together in a state before the display device according to an embodiment is expanded, and FIG. 13 shows the slidable device, the first guide rail, and the second guide rail together in a state after the display device according to an embodiment is expanded.

Referring to FIG. 12 and to FIG. 13, the housing 180 (refer to FIG. 2) of the display device according to an embodiment includes a first guide rail 183 corresponding to the guide stick 147 and a second guide rail 184 corresponding to the guide protrusion 142p.

The first guide rail 183 may extend along a path along which the bending area 138f of the segment 138 slides. The guide stick 147 may be restricted to move along the first guide rail 183. That is, when the segment 138 moves, the guide stick 147 may only move along a predetermined path along the first guide rail 183, and accordingly, the motion of the segment 138 may also be restricted to move along the first guide rail 183.

The second guide rail 184 may extend along a path along which the hinge portion 141 slides. The guide protrusion 142p may be restricted to move along the second guide rail 184. That is, when the hinge portion 141 moves, the guide protrusion 142p may only move along a path set by the second guide rail 184, and accordingly the motion of the hinge portion 141 may also be restricted along the second guide rail 184.

According to an embodiment, when the display device slides, the guide stick 147 and the guide protrusion 142p slide along the first guide rail 183 and the second guide rail 184, respectively, and thus the sliding motion of the second support portion 136 may be stably guided.

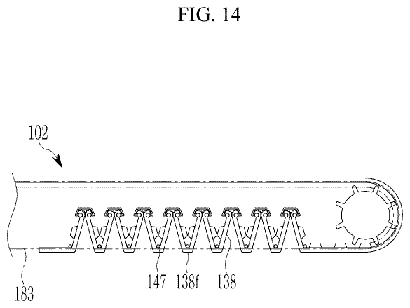

FIG. 14 shows a slidable device and a first guide rail of a display device in a state of before being expanded according to another embodiment.

Referring to FIG. 14, a housing of a display device 102 according to an embodiment includes a first guide rail 183 corresponding to a guide stick 147. In such an embodiment, as shown in FIG. 14, the second guide rail 184 corresponding to the guide protrusion shown in FIG. 12 may be omitted.

The first guide rail 183 may extend along a path along which a bending area 138f of a segment 138 slides. The guide stick 147 may be restricted to move along the first guide rail 183. That is, when the segment 138 moves, the guide stick 147 may only move along a predetermined path along the first guide rail 183, and thus the motion of the segment 138 may also be restricted to move along the first guide rail 183.

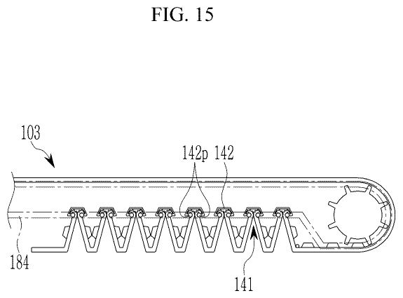

FIG. 15 shows a slidable device and a second guide rail of a display device in a state of before being expanded according to another embodiment.

Referring to FIG. 15, a housing of a display device 103 according to an embodiment include a second guide rail 184 corresponding to a guide protrusion 142p. In such an embodiment, as shown in FIG. 15, a guide stick and a first guide rail corresponding to the guide stick shown in FIG. 12 may be omitted.

The second guide rail 184 may extend along a path where the hinge portion 141 slides. The guide protrusion 142p may be restricted to move along the second guide rail 184. That is, when the hinge portion 141 moves, the guide protrusion 142p may only move along a predetermined path with the second guide rail 184, and accordingly, the motion of the hinge portion 141 may also be restricted to move along the second guide rail 184.

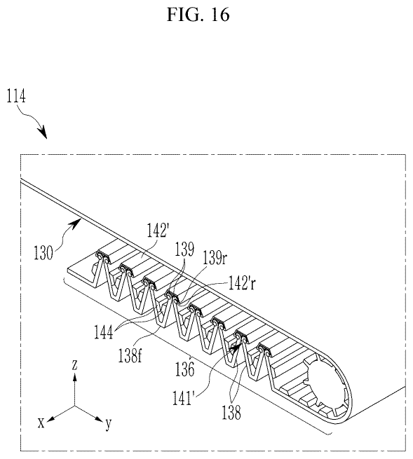

FIG. 16 is a perspective view of a slidable device applied to a display device according to another embodiment.

Referring to FIG. 16, in a slidable device 114 according to an embodiment, a second support portion 136 of a support plate 130 includes a plurality of hinge portions 141′. Each of the plurality of hinge portions 141′ may include a pair of joining edges 139 in which a pair of divided segments 138 are joined adjacent to each other. Each of the plurality of hinge portions 141′ may be covered by a hinge cap 142′ extending in a first direction (x-axis direction in the drawing).

The hinge cap 142′ may be joined to the segment 138 by inserting a fastening rod 142′r into a fastening groove 139r of the joining edge 139. In another embodiment, even after the hinge cap 142′ is joined to the joining edge 139, the fastening rod 142′r may not protrude in the first direction from the joining edge 139. In such an embodiment, a guide protrusion protruding from the fastening rod 142′r may not be formed.

In an embodiment, a pair of track bars 144 may be disposed between a pair of hinge portions 141′, and a second support portion 136 between the pair of track bars 144 may include a bending area 138f that can be folded and unfolded. In another embodiment, a guide stick may not be disposed in the bending area 138f.

Therefore, when the slidable device 114 according to an embodiment is accommodated in an internal space of the housing and driven, the slidable device 114 may slide without a guide rail. In such an embodiment, other configurations of the slidable device 114 may be substantially the same as those of the embodiments described above with reference to FIG. 6 to FIG. 8.

A display device according to an embodiment may be applied to various electronic devices. An electronic device according to an embodiment may include the display device and may further include modules or devices with additional functions other than the display device.

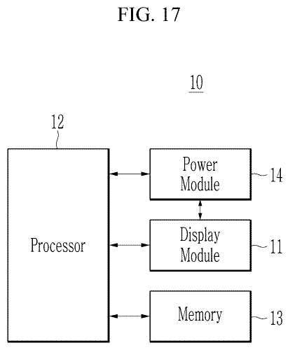

FIG. 17 is a block diagram of an electronic device according to an embodiment. Referring to FIG. 17, the electronic device 10 according to an embodiment may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and a controller. In an embodiment, the processor 12 may be divided into two or more parts from a functional or structural perspective. For example, the processor (12 may include a main processor in the form of a first driving chip that includes a central processing unit, and an auxiliary processor in the form of a second driving chip that includes a controller which receives image signals from the main processor and processes the image signals to match the interface specifications of the display module 11).

The memory 15 may include at least one of non-volatile memory and volatile memory. The memory 15 may store data information necessary for operations of the processor 12 or the display module 11). When the processor 12 executes an application stored in the memory 15), video data signals and/or input control signals are transmitted to the display module 11), and the display module 11 can process the received signals to output video information through the display screen.

The power module 14 may include a power supply module such as a power adapter or battery device, and a power conversion module that converts the power supplied by the power supply module to generate the power necessary for the operation of the electronic device 10). Power conversion by the power conversion module may include, but is not limited to, DC-DC conversion, AC-DC conversion, and DC-AC conversion.

At least one of components of the electronic device 10 may be included in the display device according to the above-described embodiments. Additionally, some of the individual modules functionally included in a single module may be incorporated within the display device, while others may be provided separately from the display device. For example, the display device may include the display module 11 and the auxiliary processor of the processor 12, while the main processor of the processor 12, memory 13, and power module 14 may be provided in the form of other devices within the electronic device 10 that are not the display device. In another example, the power module 14 may be provided within the display device and supply power to the processor 12 and memory 13 provided in the electronic device 10 that is not the display device, and is not limited to the above examples.

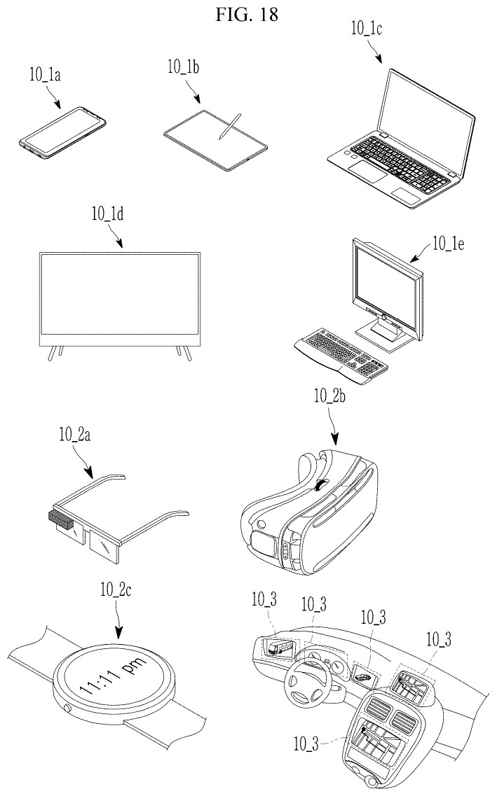

FIG. 18 shows schematic diagrams of electronic devices according to various embodiments.

Referring to FIG. 18, various electronic devices with the display device according to an embodiment may include not only image display electronic devices such as smartphones 10_1a, tablet PCs 10_1b, laptops 10_1c, TVs 10_1d, and desktop monitors 10_1e, but also wearable electronic devices incorporating display modules such as smart glasses 10_2a, head-mounted displays 10_2b, and smart watches 10_2c, as well as automotive electronic devices 10_3 incorporating display modules such as those placed on vehicle instrument panels, center fascias, dashboards, CID (Center Information Display), room mirror displays, and so on.

The electronic devices of FIG. 18 may include the configurations shown in FIG. 17. For example, the smartphone 10_1a may include the display module 11, processor 12, memory 13, and power module 14 shown in FIG. 17. The smartphone 10_1a may further include a communication module and a battery device. Power provided from the battery device may be converted through the power module 14 and supplied to the processor 12, memory 13, and display module 11. In an embodiment, the display device applied to the smartphone 10_1a may include the display module 11 and may further include the power module 14. The processor 12 and memory 13 may be provided in the form of chips mounted on an external device such as a motherboard, but are not limited to this.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display device comprising:
a display panel defining a screen, wherein the display panel includes a first screen portion and a second screen portion, which are distinct from each other;
a support plate including a first side and a second side, which are opposite to each other, wherein the display panel is attached to the first side, and the support plate includes a first support portion corresponding to the first screen portion and a second support portion corresponding to the second screen portion;
a hinge portion disposed in the second support portion, wherein the hinge portion allows the second support portion to be folded and unfolded;
a hinge cap protruding from the second side while covering the hinge portion; and
a drive roller including gear teeth protruding from an external circumferential surface thereof to interlock with the hinge cap.

2. The display device of claim 1, wherein
the hinge portion comprises a pair of joining edges to which a pair of divided segments of the second support portion are rotatably joined, respectively, and
the hinge cap defines a space in which the pair of joining edges is accommodated.

3. The display device of claim 2, wherein
the pair of joining edges has a rotating gear-engaged structure.

4. The display device of claim 2, wherein
each of the pair of joining edges includes a fastening groove extending in a first direction, and
the hinge cap comprises a fastening rod which extends in the first direction and is engaged in the fastening groove.

5. The display device of claim 1, wherein
the hinge cap includes a top surface facing the external circumferential surface when meeting the drive roller and a pair of side surfaces facing the gear teeth, and
the pair of side surfaces extend from the top surface in directions away from each other.

6. The display device of claim 1, wherein
the hinge portion comprises a pair of hinge portions which are adjacent to each other, and
the display device further comprises a pair of track bars which protrudes from the second side between the pair of hinge portions and extends in a first direction in the second support portion.

7. The display device of claim 1, wherein
the hinge portion comprises a pair of hinge portions which are adjacent to each other, and
the second support portion comprises a bending area which is folded and unfolded and disposed between the pair of hinge portions.

8. The display device of claim 7, further comprising:
a guide stick extending in a first direction on the second side in the bending area.

9. A display device comprising:
a display panel defining a screen, wherein the display panel includes a first screen portion and a second screen portion, which are distinct from each other;
a housing defining an internal space in which the display panel is accommodated, wherein an opening, through which the screen is exposed, is defined in the housing, and the housing is configured to be reduced for exposure of the first screen portion or expanded for exposure of the first screen portion and the second screen portion;
a support plate at least partially accommodated in the internal space of the housing, wherein the support plate includes a first side and a second side, which are opposite to each other, the display panel is attached to the first side, and the support plate includes a first support portion corresponding to the first screen portion and a second support portion corresponding to the second screen portion;
a hinge portion disposed in the second support portion, wherein the hinge portion allows the second support portion to be folded and unfolded;
a hinge cap protruding from the second side while covering the hinge portion; and
a drive roller accommodated in the internal space of the housing, wherein the drive roller includes gear teeth protruding from an external circumferential surface thereof to interlock with the hinge cap.

10. The display device of claim 9, wherein
the hinge portion comprises a pair of hinge portions which are adjacent to each other, and
the second support portion comprises a bending area which is folded and unfolded and disposed between the pair of hinge portions.

11. The display device of claim 10, further comprising:
a guide stick extending in a first direction on the second side in the bending area.

12. The display device of claim 9, wherein
the hinge portion comprises a pair of joining edges to which a pair of divided segments of the second support portion are rotatably joined, respectively, and
the hinge cap defines a space in which the pair of joining edges is accommodated.

13. The display device of claim 12, wherein
each of the pair of joining edges includes a fastening groove extending in a first direction, and
the hinge cap comprises a fastening rod which extends in the first direction and is engaged in the fastening groove.

14. A slidable device comprising:
a support plate including a first side and a second side, which are opposite to each other, wherein the support plate includes a first support portion and a second support portion, which are distinct from each other;
a hinge portion disposed in the second support portion, wherein the hinge portion allows the second support portion to be folded and unfolded;
a hinge cap protruding from the second side while covering the hinge portion; and
a drive roller including gear teeth protruding from an external circumferential surface thereof to interlock with the hinge cap.

15. The slidable device of claim 14, wherein
the hinge portion comprises a pair of hinge portions which are adjacent to each other, and
the slidable device further comprises a pair of track bars which protrudes from the second side between the pair of hinge portions and extends in a first direction in the second support portion.

16. The slidable device of claim 15, wherein
the second support portion includes a bending area which is folded and unfolded and disposed between the pair of track bars.

17. The slidable device of claim 14, wherein
the hinge portion comprises a pair of joining edges to which a pair of divided segments of the second support portion are rotatably joined, respectively, and,
the hinge cap defines a space in which the pair of joining edges is accommodated.

18. The slidable device of claim 17, wherein
the pair of joining edges has a rotating gear-engaged structure.

19. The slidable device of claim 17, wherein
each of the pair of joining edges includes a fastening groove extending in a first direction, and
the hinge cap comprises a fastening rod which extends in the first direction and is engaged in the fastening groove.

20. The slidable device of claim 14, wherein
the hinge cap includes a top surface facing the external circumferential surface when meeting the drive roller and a pair of side surfaces facing the gear teeth, and
the pair of side surfaces extend from the top surface in directions away from each other.
